(19) United States
(12) Patent Application Publication
(10) Pub. No.: US 2004/0010368 A1
(43) Pub. Date: Jan. 15, 2004

(54) Assisted GPS signal detection and processing system for indoor location determination

(76) Inventor: Logan Scott, Breckenridige, CO (US)

Correspondence Address: Brian M. Berliner, O'MELVENY & MYERS LLP, 400 South Hope Street, Los Angeles, CA, 90071-2899, US

(21) Appl. No.: 10/193,586

(22) Filed: Jul. 10, 2002

(51) Int. Cl. G01C 21/00

(52) U.S. Cl. 701/213; 342/357.12

(57) ABSTRACT

An assisted GPS signal detection and processing system enables an end user to obtain position information from satellite navigation signals in indoor environments that have excess signal attenuation. The system includes a master navigation signal receiver having an antenna disposed with clear sky access to a plurality of navigation satellites. The master navigation signal receiver receives satellite navigation signals from the plurality of navigation satellites, and relays an assisted satellite navigation signal to a plurality of end user signal receivers via a medium. The assisted navigation signal includes at least one of satellite location information, clock correction information, and frequency discipline information. The end user signal receivers each have an antenna for receiving the satellite navigation signals directly. The end user signal receivers are also coupled to the medium to receive the assisted navigation signal from the master navigation signal receiver. The satellite navigation signals received by the end user signal receivers via the antennas may be at least partially attenuated due to passing through physical structures. The end user signal receivers are able to recover end user position information from the attenuated satellite navigation signals by use of the assisted navigation signal.

### BACKGROUND OF THE INVENTION

1. Field of the Invention

The present invention relates to satellite navigation systems, and more particularly, to a system that improves performance of conventional satellite navigation systems in indoor environments that have excess signal attenuation.

2. Description of Related Art

Satellite navigation systems are well known in the art for use in providing pinpoint information regarding a user's location. One such satellite navigation system, known as Global Positioning System or GPS, consists of a constellation of twenty-four satellites spaced within six orbital planes roughly 20,000 kilometers above the Earth. The GPS satellites transmit two specially coded carrier signals, including the L1 signal for civilian use and the L2 signal for military and governmental use. GPS receivers process the signals to compute the user's position within a radius of ten meters or better as well as an accurate time measure. Other satellite navigation systems that presently operate or are intended to operate in the future using similar techniques include the GALILEO satellite radio navigation system, an initiative launched by the European Union and the European Space Agency, and the GLONASS (GLObal NAvigation Satellite System) satellite radio navigation system operated by the Russian Federation.

The course/acquisition (C/A) signal is one of the signals modulated on the L1 carrier. The C/A code is used to determine pseudorange (i.e., the apparent distance to the satellite), which is then used by the GPS receiver to determine position. The C/A code is a pseudo-random noise (PN) code, meaning that it has the characteristics of random noise, but is not really random. To the contrary, the C/A code is very precisely defined. There are thirty-seven PN sequences used for the C/A code, and each GPS satellite broadcasts a different code. The PN sequence contains no data; it is simply an identifier; however, its timing is very precisely determined, and that timing is used to determine the pseudorange. The PN sequences are a sequence of zeros and ones (binary), with each zero or one referred to as a “chip” rather than a bit to emphasize that the zeros and ones do not carry data. The C/A signal has a 1.023 MCh/sec chipping rate and a code length of 1,023, so it repeats itself after every 1 msec interval.

Another signal modulated onto the L1 carrier is the broadcast data message, which includes information describing the positions of the satellites. Each satellite sends a full description of its own orbit and clock calibration data (within the ephemeris information) and an approximate guide to the orbits of the other satellites (contained within the almanac information). The broadcast data message is modulated at a much slower rate of 50 bps.

In order to receive a GPS signal and measure the pseudorange to the satellite, a GPS receiver performs a correlation process in which a search is conducted for the satellite's unique PN code. The received signal is checked against all of the possible PN codes. The GPS receiver generates each of these codes and checks for a match. Even if the GPS receiver generates the right PN code, it will only match the received signal if it is lined up exactly. Because of the time delay between broadcast and reception, the received signal also has to be given a time delay. When a match is found, the GPS receiver identifies the PN code (and therefore the satellite). Using the ephemeris and clock calibration data contained in the 50 bps broadcast data message, the GPS receiver can calculate the time delay (and therefore the pseudorange).

More particularly, the correlation process is conducted in a carrier frequency dimension and a code phase dimension. In the carrier frequency dimension, the GPS receiver replicates carrier signals to match the frequencies of the GPS signals as they arrive at the receiver. But, due to the Doppler effect, the frequency f at which the GPS signal is transmitted by the satellite changes by an amount Δf before the signal arrives at the receiver. Thus, the GPS signal should have a frequency f+Δf when it arrives at the receiver. During search and acquisition, to account for the Doppler effect, the GPS receiver replicates the carrier signals across a frequency spectrum until the frequency of the replicated carrier signal matches the frequency of the received signal. Similarly, in the code phase dimension, the GPS receiver replicates the unique PN codes associated with each satellite. The phases of the replicated PN codes are shifted across a code phase spectrum until the replicated carrier signals modulated with the replicated PN codes correlate, if at all, with GPS signals received by the receiver. The code phase spectrum includes every possible phase shift for the associated PN code.

The correlation process is implemented by a correlator that performs a multiplication of a phase-shifted replicated PN code modulated onto a replicated carrier signal with the received GPS signals. The GPS receiver essentially performs a search of two parameters: Range and Doppler. The receiver divides the field of uncertainty into Range/Doppler bins and looks in each bin to see if that corresponds to a correct pair of values. Setting the carrier frequency and code phase has the effect of tuning the correlator to a particular Range/Doppler combination. The envelope response peaks when the correlator is tuned to the appropriate Range/Doppler combination. Otherwise, unless the tuning is close to the correct values, the envelope response is minimal. Once properly tuned, the receiver can recover the navigation data from the detected GPS signals and use the navigation data to determine a location for the receiver.

For satellite navigation systems to provide accurate location information, it is necessary that the receiver have a clear view of at least three satellites. A two-dimensional position (i.e., latitude and longitude) can be derived from simultaneous signals received from three satellites, and a three-dimensional position (i.e., latitude, longitude and altitude) can be derived from simultaneous signals received from four or more satellites. But, if the receiver is located in an indoor environment, such as within a building or other physical structure, signal attenuation by the structure prevents the receiver from receiving sufficiently strong signals from the minimum number of satellites needed to determine the position of the user. For example, the roof and walls of the structure may attenuate the satellite signal by a factor of one hundred (20 dB) or more. Multistory buildings provide even greater attenuation by multiplying the extent of physical structure through which the satellite signal must pass before reaching the receiver. As a result, a significant drawback of conventional satellite navigation systems has been their inability to provide position information within most indoor environments.

Recent advancements in signal processing technology have improved the ability of satellite navigation systems in an attempt to overcome the signal attenuation problem. Using a technology referred to as Assisted-GPS (or A-GPS), attenuated satellite signals can be received in certain environments and processed to yield time and position information. The impetus behind the development of A-GPS is a Federal Communications Commission (FCC) mandate requiring that all wireless carriers provide the location of an emergency 911 caller to the appropriate public safety answering point. A-GPS systems generally include a combination of network-based assistance and so-called “massive correlator” technology. Network-based assistance refers to the use of an A-GPS server coupled to a wireless network that provides location prediction information to the network end users. The A-GPS server includes a reference GPS receiver having unobstructed access to the satellites. The A-GPS server processes the satellite signals to predict the GPS signal the wireless handsets will receive, and conveys that prediction information to the handsets. Using the prediction information, an A-GPS receiver in the handset can detect and demodulate weaker signals than a conventional GPS receiver. Because the network performs the location calculations, the handset only needs to contain a scaled-down GPS receiver.

Under normal conditions, it takes the correlator only a few milliseconds to perform the search of Range/Doppler bins. When the satellite signals are weak, however, it may take much longer to look in each bin. Since there may be thousands, and often tens of thousands, of Range/Doppler bins in which to look, a conventional GPS receiver that has only a few correlators would therefore be impractical to search for weak signals in a reliable manner. The A-GPS receivers address this problem by including large numbers of correlators that operate in parallel to search a plurality of PN codes across the frequency spectrum and the code phase spectrum. Each one of the correlators searches for a particular PN code across each possible frequency within the frequency spectrum and for each possible phase shift for that PN code. This process may be repeated many times until all PN codes are collectively searched for by the plurality of correlators. But, even with thousands of correlators, it will still take an excessive amount of time to locate weak satellite signals if all Range/Doppler combinations are searched. Another drawback of this “massive correlator” approach is that it necessarily increases the cost and complexity of the GPS receiver.

Accordingly, it would be desirable to provide a system that improves performance of conventional satellite navigation systems in indoor environments that have excess signal attenuation.

### SUMMARY OF THE INVENTION

The present invention overcomes these and other drawbacks of the prior art by providing a system for obtaining position information from satellite navigation signals in indoor environments that have excess signal attenuation.

Generally, the system includes a master navigation signal receiver having an antenna disposed with clear sky access to a plurality of navigation satellites. The master navigation signal receiver receives satellite navigation signals from the plurality of navigation satellites, and relays an assisted satellite navigation signal to a plurality of end user signal receivers via a medium. The assisted navigation signal includes at least one of satellite location information, clock correction information, and frequency discipline information. The end user signal receivers each have an antenna for receiving the satellite navigation signals directly. The end user signal receivers are also coupled to the medium to receive the assisted navigation signal from the master navigation signal receiver. As discussed above, the satellite navigation signals received by the end user signal receivers via the antennas may be at least partially attenuated due to passing through physical structures. The present invention overcomes this problem by enabling the end user signal receivers to recover end user position information from the attenuated satellite navigation signals by use of the assisted navigation signal.

More particularly, the end user signal receivers further comprise at least one correlator adapted to correlate received satellite navigation signals to known pseudorandom codes for the satellites by searching a plurality of Range and Doppler combinations of the pseudorandom codes. The assisted navigation signal provides the end user signal receivers with satellite location information that permits the end user receivers to determine pseudorange to the satellites and thereby reduce the plurality of Range and Doppler combinations in a Range dimension. The assisted navigation signal also provides the end user signal receivers with clock correction information that permits the end user receivers to determine a time bias of the satellite navigation signals and thereby reduce the plurality of Range and Doppler combinations in a Doppler dimension. These and other aspects of the present invention enable a significant reduction in the number of correlators necessary to process attenuated satellite navigation signals.

In a first exemplary embodiment of the invention, the master navigation signal receiver translates the received satellite navigation signals to an alternate frequency, and relays the translated signals to the end user signal receivers. The translated signals are sent to the end user signal receivers over a cable plant. For example, the satellite navigation signals may be translated to a frequency corresponding to a vacant NTSC television channel.

In a second exemplary embodiment of the invention, the master navigation signal receiver provides a disciplined pilot signal to the end user signal receivers. The disciplined pilot signal contains the 50 bps broadcast data message from all satellites in view to the master navigation signal receiver. As in the previous embodiment, the translated signals are sent to the end user signal receivers over a cable plant.

In a third exemplary embodiment of the invention, the master navigation signal receiver translates the received satellite navigation signals to an alternate frequency, and relays the translated signals to the end user signal receivers via an RF communication channel.

In a fourth exemplary embodiment of the invention, the master navigation signal receiver provides a disciplined pilot signal to the end user signal receivers via an RF communication channel.

In a fifth exemplary embodiment of the invention, the master navigation signal receiver provides an assisted GPS signal (either a translated signal as in the first and third embodiments, or a disciplined pilot signal as in the second and fourth embodiments) via the cable plant to a plurality of RF outlets. The RF outlets reradiate the assisted GPS signal via an RF communication channel to the end user signal receivers.

A more complete understanding of the assisted GPS signal detection and processing system for indoor location determination will be afforded to those skilled in the art, as well as a realization of additional advantages and objects thereof, by a consideration of the following detailed description of the preferred embodiment. Reference will be made to the appended sheets of drawings, which will first be described briefly.

### BRIEF DESCRIPTION OF THE DRAWINGS

FIG. 1 is a schematic diagram of a conventional hybrid fiber cable plant;

FIG. 2 is a block diagram of a master GPS signal translator in accordance with a first embodiment of the invention;

FIG. 3 is a block diagram of an A-GPS user equipment device for receiving translated GPS signals over the cable plant;

FIG. 4 is a block diagram of a dual band parallel GPS front end of the A-GPS user equipment device of FIG. 3;

FIG. 5 is a block diagram of a master GPS pilot signal generator in accordance with a second embodiment of the invention;

FIG. 6 is a block diagram of an A-GPS user equipment device for receiving GPS pilot signals over the cable plant;

FIG. 7 is a block diagram of an indoor RF outlet distribution system in accordance with a third embodiment of the invention;

FIG. 8 is a block diagram of an A-GPS user device for use with the RF outlet distribution system;

FIG. 9 is a block diagram a dual band parallel GPS front end of the A-GPS user equipment device of FIG. 8;

FIG. 10 is a block diagram of an indoor RF outlet distribution system in accordance with a fourth embodiment of the invention;

FIG. 11 is a block diagram of an A-GPS user device for use with the RF outlet distribution system; and

FIG. 12 is a block diagram of an RF outlet distribution system through the cable plant in accordance with a fifth embodiment of the invention.

### DETAILED DESCRIPTION OF THE PREFERRED EMBODIMENT

The invention satisfies the need for a system that improves performance of conventional satellite navigation systems in indoor environments that have excess signal attenuation. In the detailed description that follows, like element numerals are used to describe like elements illustrated in one or more of the figures.

Generally, the invention provides an assisted GPS (A-GPS) system that enables end users to obtain indoor location information using assistance data delivered through a medium such as an existing cable plant. As known in the art, a cable plant refers to the physical infrastructure (e.g., wire, connectors, cables, etc.) used to carry data communications signals between data communications equipment. In a preferred embodiment of the invention, the cable plant refers to a cable television service provider network connected to business and residential customers within a defined geographic area, though it should be appreciated that the inventive concepts described below are also applicable to other forms of signal distribution networks.

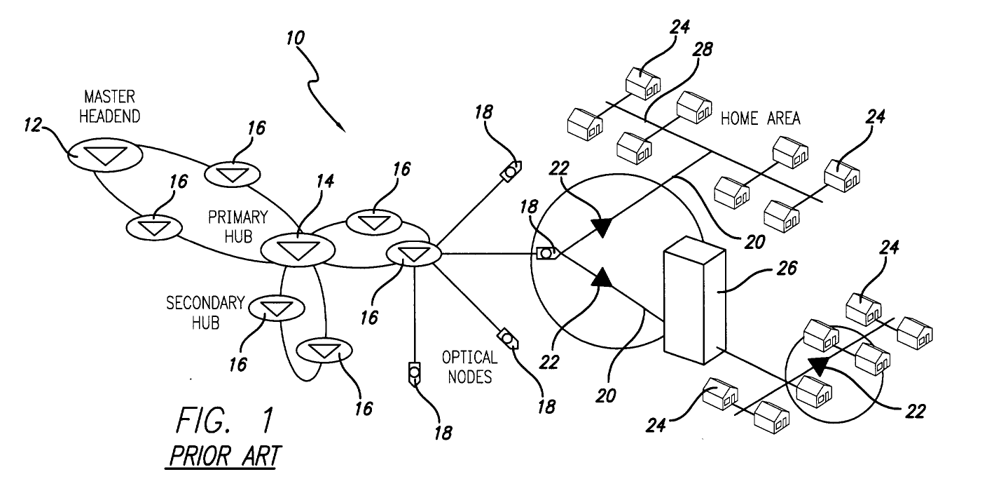

Modern cable television service has moved beyond traditional analog television signals distribution and into diverse telecommunications roles that include digital television, Internet access, voice telephony, videoconferencing, digital data distribution, and various interactive services. This diverse mix of services is typically supported via a hybrid fiber coax cable plant, as illustrated in FIG. 1. The exemplary cable plant 10 includes a headend 12 that receives external signals such as satellite, microwave, and local TV station broadcasts from various types of deployed antennas. The headend 12 processes, combines, and assigns a channel frequency to all signals destined for cable distribution. The headend 12 is connected to a core distribution infrastructure that is typically provided by fiber optic connections. The fiber optic connections are usually deployed in a ring architecture to improve service reliability during disruptions due to cable cuts, equipment failures, etc.

As shown in FIG. 1, the headend 12 is connected to a primary hub 14 through an exemplary ring architecture, and the primary hub 14 is in turn connected to a plurality of secondary hubs 16. The secondary hubs 16 may each be connected to a plurality of optical nodes 18 that provide an interface with trunk lines 20 that connect to residential and commercial customers 24, 26 through coaxial cable. The trunk lines 20 share the same properties as do generic transmission lines with regard to attenuation; in order to maintain adequate signal strength over long distances, amplifiers 22 are required at regular intervals. Smaller distribution or feeder cables 28 branch out from the trunk lines 20 and are responsible for serving local neighborhoods. Feeder cables 28 are tapped at periodic locations to furnish coaxial drop cables that enter directly into the customer's premises. Terminal equipment (not shown) is connected to the drop cable inside the premises for connection to televisions, videocassette recorders (VCRs), set-top boxes, converters, de-scramblers, splitters, cable modems, and the like.

The cable plant 10 uses linear modulation to distribute the composite of signals from the headend 12. With the exception of plant distortions, the composite signal waveform received by the end user is substantially the same as that produced at the headend 12. Signals that flow from the headend 12 to the user are referred to as downstream signals, while those that flow from the user to the headend 12 are referred to as upstream signals. All hybrid fiber coax cable plants support distribution of downstream signals, but not all support upstream signals. Upstream and downstream transmissions are separated in frequency. For example, the cable plant may use the 5-42 MHz band for upstream and the 50-860 MHz band for downstream, with the 42-50 MHz band used as a guard band having sufficient bandwidth so filtering can be used to separate the two directions without excessive loss.

In accordance with certain embodiments of the present invention, the cable plant is used to deliver to the end user an A-GPS signal that enables the end user receiver to receive and process attenuated satellite signals. A GPS receiver at the headend 12 having unobstructed sky access to the GPS satellites receives the satellite signals and provides the A-GPS signal to the end users via the cable plant. The A-GPS signal assists the end user receiver in two respects. First, the A-GPS signal includes the 50 bps broadcast data message containing satellite orbital information and clock correction parameters for all satellites in view at the headend location. This information helps the end user receiver figure out where the GPS satellites are as well as the pseudorange to the satellites. Second, the satellite orbital information and clock correction parameters can be used to narrow down the search of Range/Doppler bins by eliminating unlikely combinations. By knowing how the GPS satellites move as a function of time and an approximate location for the end user, the end user receiver can predict better which Range/Doppler combinations are likely to result in a correlation, thereby reducing the numbers of correlators that are employed for this purpose.

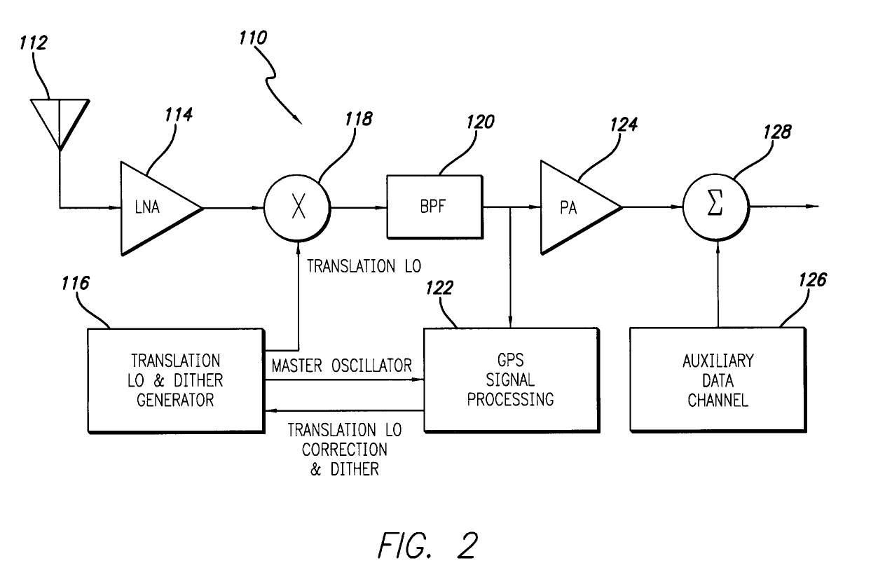

A first embodiment of the invention is illustrated with respect to FIGS. 2-4. FIG. 2 illustrates a block diagram of a master GPS signal translator 110. The master GPS signal translator 110 has an L1 antenna 112 located at the headend 12 so as to have clear sky access. The master GPS signal translator 110 would translate a modestly filtered version of the entire L1 modulated carrier to another frequency within the downstream capability of the cable plant. Because GPS uses Code Division Multiple Access (CDMA), signals from all GPS satellites in view of the master GPS signal translator 110 will be injected into the cable plant by this process. Since the L1 modulated carrier has an approximate bandwidth of 2 MHz, a single vacant NTSC (i.e., National Television Standards Committee) format television channel (i.e., 6 MHz bandwidth) could be used for transport purposes. The L1 modulated carrier is broadcast at a center frequency of approximately 1.54275 GHz. The master GPS signal translator 110 translates the L1 modulated carrier down to a lower center frequency.

The master GPS signal translator 110 further comprises a low noise amplifier (LNA) 114, a translation local oscillator 116, a mixer 118, a bandpass filter 120, and a power amplifier 124. The L1 antenna 112 positioned with clear sky access receives the L1 modulated carrier and passes that signal through the LNA 114 to the mixer 118. The translation local oscillator 116 produces a precise translation local oscillator (LO) signal that is provided to the mixer 118. The translation LO signal has a frequency selected so as to translate the L1 modulated carrier to the selected vacant NTSC television channel. The mixer 118 combines the received L1 modulated carrier with the translation LO signal to translate (or downconvert) the received L1 modulated carrier to a lower center frequency. The translated L1 modulated carrier is passed through the bandpass filter 120 to eliminate any extraneous frequency components that extend beyond the selected satellite signal bandwidth. Then, the power amplifier 124 boosts the filtered signal to a broadcast level. The amplified, filtered, and translated L1 modulated carrier is then injected into the cable plant.

An optional auxiliary data channel 126 can carry ancillary control data, such as permissions or keys needed to access a premium channel. The auxiliary data channel 126 can also carry information useful to A-GPS receiver operation, such as the precise frequency of the translation LO signal. The master GPS signal translator 110 further comprises a summing device 128 that combines the translated L1 modulated carrier with the auxiliary data channel 126 prior to injection into the cable plant. It is anticipated that the auxiliary data channel 126 include authentication and encryption features to permit system wide over-the-air-rekeying (OTAR) functionality, i.e., changing traffic encryption key or transmission security key in remote crypto-equipment by sending new key directly to the remote crypto-equipment over the communication path it secures.

The auxiliary data channel may be configured to look like a GPS signal. As discussed above, there are thirty-seven PN codes used for the C/A code modulated on the L1 carrier. But, out of 1,025 possible PN codes, there are hundreds that have not yet been reserved for use. One of the unused PN codes could be used for the auxiliary data channel. The signal communicated on the auxiliary data channel would then resemble a GPS signal from the perspective of signal spectrum, but the data content would be different. Multiple auxiliary channels, each configured using a distinct PN code, might be used to carry distinct data.

To minimize the number of correlators in the end user receiver, the frequency of the translation LO signal should be known with high precision. The translation local oscillator 116 can be adapted to provide a highly accurate translation LO signal, such as using oven controlled crystal oscillators (OCXO), i.e., high performance crystal oscillators that employ temperature control circuitry to hold the crystal and critical circuitry at a precise, constant temperature, or a highly accurate Rubidium (Rb) standard clock. Since these solutions are expensive, an alternative approach is to include GPS signal processing device 122 coupled to the signal path to receive the translated and filtered L1 modulated carrier prior to the amplification stage. The GPS signal processing device 122 can recover the highly accurate clock calibration signals from the L1 modulated carrier, and use those signals to precisely measure the frequency of a master oscillator signal produced by the translation local oscillator 116. Corrections to the master oscillator signal can be conveyed back to the translation local oscillator 116 directly for application by a dither generator, or can be injected into the cable plant via the auxiliary data channel 126 for use by the end user receiver.

In a preferred embodiment of the invention, the dither generator comprises a fine frequency resolution Numerically Controlled Oscillator (NCO) used to make small frequency adjustments to the translation LO signal. Corrections may be imposed using a Single Side Band (SSB) mixer or a double balanced mixer followed by a filter to select the sum or difference frequency. To provide the best precision, the NCO should be clocked off the master oscillator. The dither generator may also include a pseudorandom frequency modulation component in order to provide a measure of authentication and encryption of the translated L1 modulated carrier. This would prevent unauthorized end users from obtaining precise frequency and time via the cable plant.

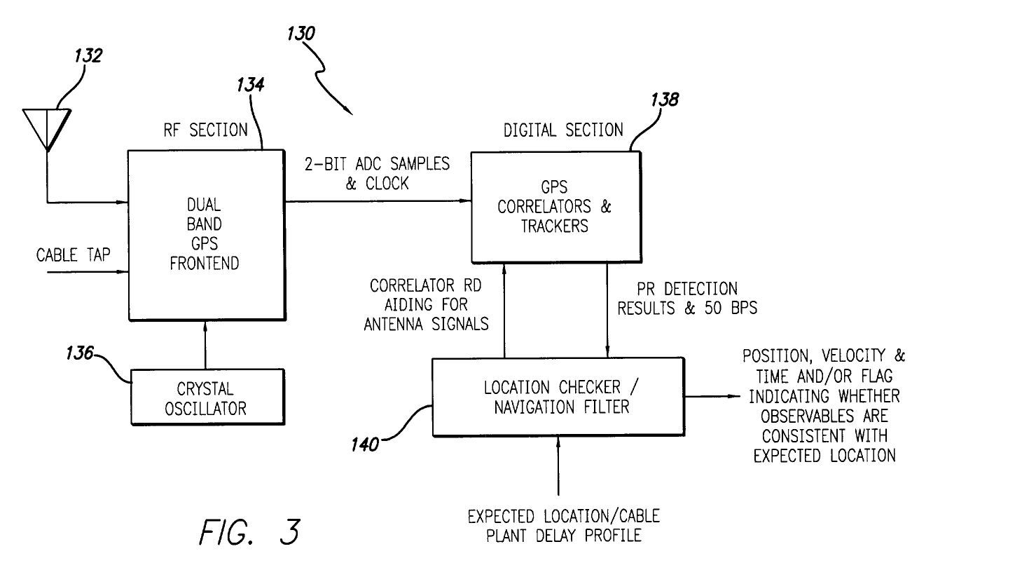

FIG. 3 illustrates a block diagram of an A-GPS end user receiver 130. The end user receiver 130 would be connected to the cable plant 10 at the end user location, e.g., the residential and commercial customers 24, 26. The end user receiver 130 may be included as part of the terminal equipment (e.g., set top box, cable modem, VoIP telephone, VCR, television, etc.) or may comprise a separate, stand-alone device. The end user receiver 130 comprises an L1 antenna 132, an RF section including a dual band GPS front end 134 and crystal oscillator 136, and a digital section including GPS correlators/trackers 138 and location checker/navigation filter 140. The L1 antenna 132 may be positioned indoors without clear sky access and therefore receives only an attenuated L1 modulated carrier. The dual band GPS front end 134 is connected to both the L1 antenna 132 and the cable tap in order to receive GPS signals from each of these sources.

The dual band GPS front end 134 produces digital samples (e.g., two bits per sample) and a clock signal used as the sampling rate. The crystal oscillator 136 provides the dual band GPS front end 134 with a local oscillator signal used to downconvert the GPS signals received from both the L1 antenna 132 and the cable tap, and also provides the clock signal for producing the digital samples of the RF signals. Within the digital section, the GPS correlators/trackers 138 receive the digital samples and the clock signal, and attempt to correlate the digital samples to the satellite PN codes. The correlators/trackers 138 recover the 50 bps broadcast data message and determine the pseudorange (PR) using information contained in the broadcast data message. If the GPS signals received from the L1 antenna 132 are too weak to recover the 50 bps broadcast data message, then this message can be recovered from the GPS signals received via the cable tap, which should have very favorable signal-to-noise ratio. The location checker/navigation filter 140 uses the pseudorange information from the correlators/trackers 138 to estimate Range/Doppler (RD) to assist the correlators/trackers 138 in correlating with the digital samples of GPS signals received from the L1 antenna 132 so that pseudorange information can be determined for these attenuated signals. The location checker/navigation filter 140 ultimately determines the user equipment location information. The location checker/navigation filter 140 may also generate a flag indicating whether the determined location is consistent with an expected location.

It should be appreciated that the GPS signals received via the cable tap will yield a solution that reflects the location of the headend and the cable plant delay in reaching the user equipment. The location checker/navigation filter 140 derives location and time information for the user equipment based on the following four equations using pseudorange information from the correlators/trackers 138:

\sqrt{(x_{USER}-x₁)²+(y_{USER}-y₁)²+(z_{USER}-z₁)²}+cb_{USER}=PR₁

\sqrt{(x_{USER}-x₂)²+(y_{USER}-y₂)²+(z_{USER}-z₂)²}+cb_{USER}=PR₂

\sqrt{(x_{USER}-x₃)²+(y_{USER}-y₃)²+(z_{USER}-z₃)²}+cb_{USER}=PR₃

\sqrt{(x_{USER}-x₄)²+(y_{USER}-y₄)²+(z_{USER}-z₄)²}+cb_{USER}=PR₄

where:

c=speed of light;

x_{USER}, y_{USER}, z_{USER} are the coordinates for the user's position defined in terms of the WGS-84 Earth Centered Earth Fixed (ECEF) rotating coordinate system, and b_{USER} is the internal clock time bias;

xᵢ, yₗ, zᵢ is the position of the i-th navigation satellite (i.e., satellite vehicle i); and

PRᵢ is the pseudorange to the i-th navigation satellite.

The square root terms are the geometric ranges to the individual satellites and the cb_{USER} represents a time bias term common to all measurements. More particularly, b_{USER} represents the user's clock error corresponding to the time it takes for the GPS signal to travel from the satellite to the user. The pseudorange measurements form the basic set of observables used in navigation processing. When more than four satellites are visible, an over-defined solution using well known processing techniques, e.g., Kalman filters, allows a further reduction of the sensitivity to errors in the pseudorange measurements. When fewer than four pseudorange observables are present, the location checker/navigation filter 140 can still perform location consistency checks by comparing pseudorange differences with expected values determined based on location, time and satellite ephemeris data.

In addition to providing the location of the GPS satellites used in the foregoing equations, the 50 bps broadcast data message recovered from the GPS signals received via the cable tap is advantageous in figuring out more accurately the frequency of the translation LO signal used by the master GPS signal translator 110 (see FIG. 2) to translate the GPS signals. As described above, the location checker/navigation filter 140 solves for time bias between the satellites and the headend, which is then used to derive the internal master oscillator frequency used to generate the translation LO. Alternatively, if the frequency of the translation LO is delivered over the cable plant in the auxiliary data channel, then the frequency of the translation LO may be recovered directly from that signal.

Using either method, knowledge of the frequency of the translation LO can then be used to discipline the crystal oscillator 136 used to downconvert the GPS signals in the user equipment. While it is advantageous to use a crystal oscillator since it is relatively inexpensive, a crystal oscillator is limited in that it has a frequency accuracy of only about one part per million. Given that the center frequency of the L1 modulated carrier is approximately 1.54275 GHz, the crystal oscillator error is in the range of +/−1.5 KHz @ L1. This error results in a wide range of bins that must be searched in the Doppler dimension by the correlators. It should be appreciated that any errors of the crystal oscillator 136 are going to be common to all the GPS signals received via the cable plant. In other words, if the crystal oscillator frequency is off by 1 KHz, then every signal received via the cable plant will have that same 1 KHz offset. The time bias rate solution provided by the location checker/navigation filter 140 can be used to determine the exact frequency of the crystal oscillator 136. As a result, instead of searching a broad range of bins in the Doppler dimension corresponding to the crystal oscillator error, the correlators can hone in quickly on a much narrower range of bins, thereby substantially reducing the number of correlators needed to perform the search.

The GPS signals that pass through the cable plant further experience a time delay (b_{CABLE}) before arriving at the user equipment. Note that b_{CABLE} will be different for different user equipment because the path from the headend is not identical. Referring to the above equations used to determine a position solution, the solution for the internal time bias using signals received via the cable tap will be wrong by b_{CABLE} seconds. If b_{CABLE} is known, it can provide the basis for a precise time hack. This would result in fewer Range bins having to be searched, particularly if the user equipment can determine an approximation of its location. FIG. 3 illustrates the location checker/navigation filter 140 receiving an expected location/cable plant delay profile for this purpose. The cable delay b_{CABLE} can be measured using a two-way cable modem. Several known cable modem standards (e.g., DOCSIS 1.0) incorporate provisions for measuring cable plant delay in order to facilitate efficient upstream TDMA messaging on a shared frequency channel. For fixed connection end users, it should be appreciated that b_{CABLE} should be relatively fixed in value, so that once known b_{CABLE} can be stored in memory for future use.

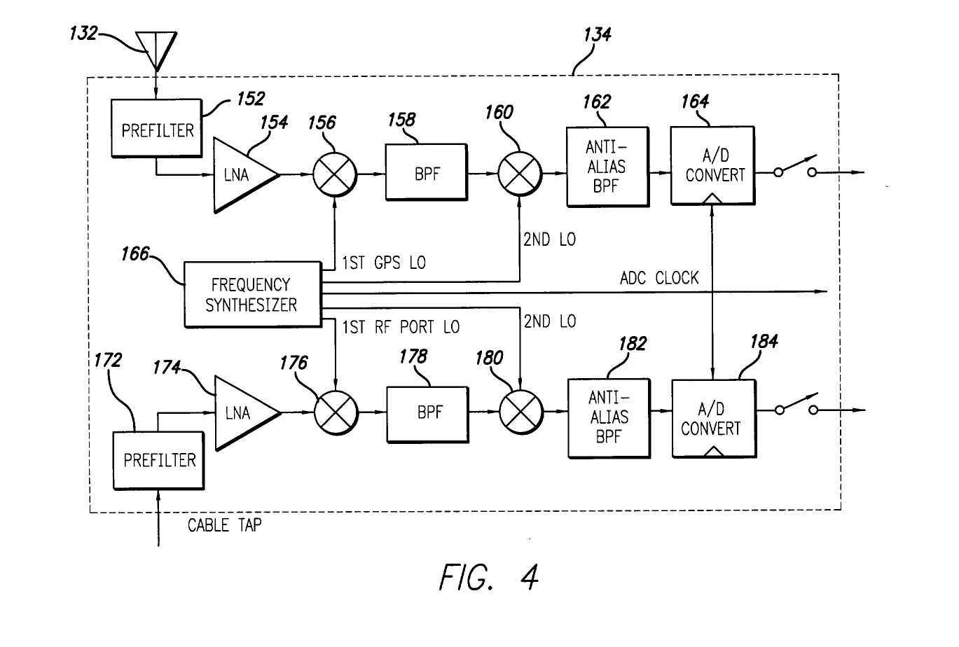

FIG. 4 shows a block diagram of an exemplary dual band GPS front end 134 in greater detail. The dual band GPS front end 134 includes two parallel signal processing streams, including a first stream for processing GPS signals received over the L1 antenna 132 and a second stream for processing GPS signals received over the cable plant 10. The first signal processing stream includes a prefilter 152, low noise amplifier 154, first mixer stage 156, bandpass filter 158, second mixer stage 160, anti-aliasing bandpass filter 162, and analog-to-digital (A/D) converter 164. Likewise, the second signal processing stream includes a prefilter 172, low noise amplifier 174, first mixer stage 176, bandpass filter 178, second mixer stage 180, anti-aliasing bandpass filter 182, and A/D converter 184. The two signal streams have a common frequency synthesizer 166.

In the first signal-processing stream, the attenuated L1 modulated carrier received at the L1 antenna 132 passes through the prefilter 152 and low noise amplifier 154 to the first mixer stage 156. The frequency synthesizer 166 provides a GPS LO signal to the first mixer stage 156 having a frequency selected to downconvert the received L1 modulated carrier to an intermediate frequency signal. The intermediate frequency L1 modulated carrier then passes through bandpass filter 158 to the second mixer stage 160. The frequency synthesizer 166 provides a second LO signal to the first mixer stage 156 having a frequency selected to downconvert the intermediate frequency L1 modulated carrier to a baseband signal. The baseband L1 modulated carrier then passes through the anti-aliasing bandpass filter 162 to eliminate aliasing effects, and is converted to a digital signal by the A/D converter 164. In the second signal processing stream, the translated L1 modulated carrier received from the cable plant is processed in substantially the same manner, except that the frequency synthesizer 166 provides an RF LO signal to the first mixer stage 176 having a frequency selected to downconvert the translated L1 modulated carrier to an intermediate frequency signal. Since the same second LO signal is used in both signal streams, both the intermediate frequency L1 modulated carrier and the translated L1 modulated carrier are downconverted to the same center frequency. This way, the correlators and trackers 138 (see FIG. 3) can operate with either signal interchangeably.

Each of the two signal streams of the dual band GPS front end 134 further includes switches on the outputs following the respective A/D converters 164, 184. The switches permit either simultaneous, parallel signal conversion, or switched operation in which only one of the signal streams is active at a given time. Parallel operation will support data wipe off, while switched operation might be used when sensitivity is less important but cost is critical.

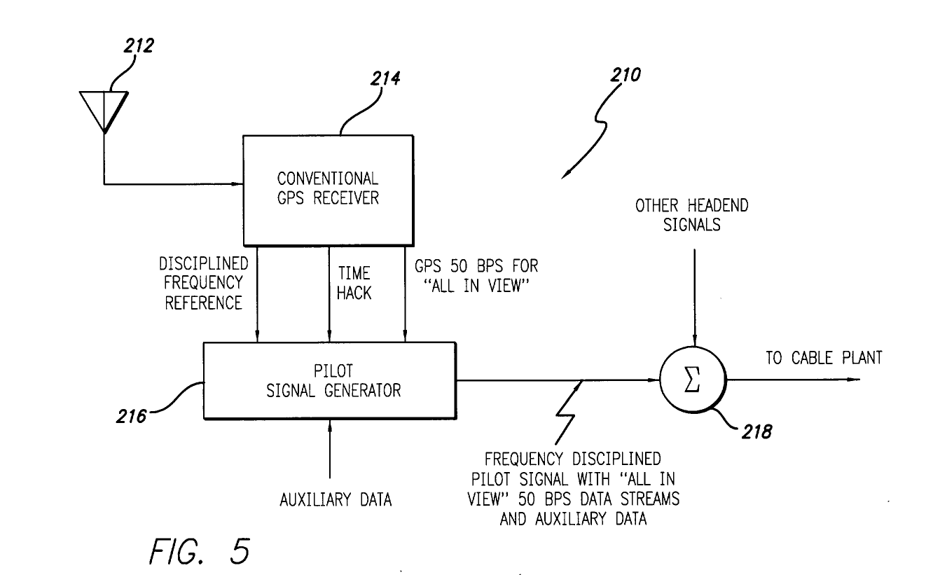

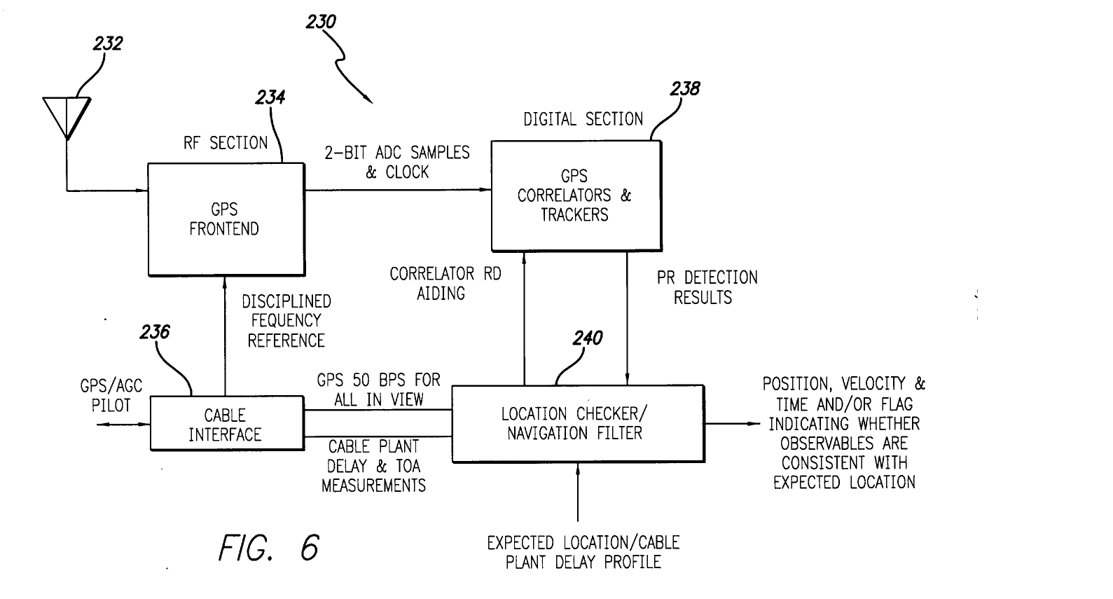

A second embodiment of the invention is illustrated with respect to FIGS. 5-6. FIG. 5 illustrates a block diagram of a master GPS pilot signal generator 210. The master GPS pilot signal generator 210 has an L1 antenna 212 located at the headend 12 so as to have clear sky access. The master GPS pilot signal generator 210 produces a pilot signal that is sent via the cable plant to an A-GPS unit at the user equipment end to assist in downconverting the received GPS signals. The master GPS signal pilot generator 210 further comprises a conventional GPS receiver 214 and a pilot signal generator 216. The L1 antenna 212 positioned with clear sky access receives the L1 modulated carrier and passes that signal to the GPS receiver 214. The GPS receiver produces a disciplined frequency reference, a time hack, and the 50 bps broadcast data messages from all satellites in view. The pilot signal generator 216 receives these three signals, and injects into the cable plant a frequency disciplined pilot signal containing the 50 bps broadcast data message. The master GPS pilot signal generator 210 further comprises a summing device 218 that combines the disciplined pilot signal with the composite of signals from the headend 12 prior to injection into the cable plant.

As in the previous embodiment, the pilot signal may also include optional auxiliary data, such as permissions or keys needed to access a premium channel and/or authentication and encryption features to permit system wide over-the-air-rekeying (OTAR) functionality. The auxiliary data is provided to the pilot signal generator 216, which combines the auxiliary data with the disciplined pilot signal.

It is anticipated that the pilot signal would have a different format than the translated GPS signals described in the previous embodiment. The pilot signal would include some form of digital modulation, such as Vestigial Side Band (VSB) or biphase shift keying (BPSK), a digital frequency modulation technique used for sending data over a coaxial cable network. The pilot signal generator 216 would read and demodulate the 50 bps broadcast data message, and format the information contained in the broadcast data message in accordance with the selected form of digital modulation.

FIG. 6 illustrates a block diagram of an A-GPS end user receiver 230 equipped to receive the pilot signal via the cable plant. The end user receiver 230 would be connected to the cable plant 10 at the end user location, e.g., the residential and commercial customers 24, 26. The end user receiver 230 may be included as part of the terminal equipment (e.g., set top box, VCR, television, etc.) or may comprise a separate, stand-alone device. The end user receiver 230 comprises an L1 antenna 232, an RF section including a GPS front end 234 and a cable interface 236, and a digital section including GPS correlators/trackers 238 and location checker/navigation filter 240. The L1 antenna 232 is positioned indoors without clear sky access and therefore receives only an attenuated L1 modulated carrier. The GPS front end 234 is connected to the L1 antenna 232 in order to receive GPS signals that may be attenuated as discussed above.

The cable interface 236 receives and demodulates the pilot signal to recover the disciplined frequency reference, the time hack, and the information contained within the 50 bps broadcast data message. The cable interface 236 provides the disciplined frequency reference to the GPS front end 234, which uses that information to discipline the crystal oscillator included therein used to downconvert the GPS signals received from the L1 antenna 232 (as described above in the previous embodiment). The GPS front end 234 produces digital samples (e.g., two bits per sample) and a clock signal used as the sampling rate. Within the digital section, the GPS correlators/trackers 238 receive the digital samples and the clock signal, and attempt to correlate the digital samples to the satellite PN codes to determine pseudorange information. The cable interface 236 provides the information contained in the 50 bps broadcast data message to the location checker/navigation filter 240, which uses that information to estimate Range/Doppler (RD) to assist the correlators/trackers 238 in correlating with the digital samples of GPS signals received from the L1 antenna 232 so that pseudorange information can be determined for these attenuated signals. The location checker/navigation filter 240 ultimately determines the user equipment location information. The location checker/navigation filter 240 may also generate a flag indicating whether the determined location is consistent with an expected location.

The cable interface 236 may additional include the ability to measure the cable plant delay (b_{CABLE}), and provide this information to the location checker/navigation filter 240. If b_{CABLE} is known, it can provide the basis for a precise time hack that would result in fewer Range bins having to be searched, particularly if the user equipment can determine an approximation of its location. Alternatively, the cable plant delay profile and expected location may be provided to the location checker/navigation filter from an alternate source, such as a stored file.

As described above, correlator counts can be reduced by providing the location checker/navigation filter 240 with a time hack of sufficient accuracy to permit searching fewer than all PN code phases. In one embodiment, an external fill device may be used to load in time and position. The fill device may include a precision oscillator (e.g., TCO, OXCO (temperature-controlled crystal oscillator or “crystal oven”) or Rubidium). Time discipline may be provided by GPS, LORAN, or some other source while exposed to appropriate signals, and the precision oscillator used to maintain an accurate time count in the absence of discipline. If the fill device can maintain access to navigation signals at the fill site, position information could also be loaded to further reduce required Range/Doppler bin searching.

In another embodiment, a two-way cable plant modem could be used as described above to measure cable plant delay. By adding a precision timeserver, precision time hacks could be provided to the A-GPS user equipment to reduce the bin searching in the Range dimension.

In yet another embodiment, the pilot signal could incorporate Direct Sequence Spread Spectrum (DSSS) modulation. By synchronizing the chipping sequence of the DSSS modulation to an accurate time source, and with an estimate of the downstream cable plant delay, time hacks could be generated at the A-GPS end user receiver 230 to reduce satellite code phase uncertainties. The cable plant delay can be measured by comparing the pilot signal time of arrival (TOA) with time recovered from the fill device (described above) or from the two-way cable plant modem (described above), or by comparing the TOA with time derived from the A-GPS navigation solution. While the first time acquisition might be slow, once the cable plant delay is known subsequent acquisitions can occur fairly quickly.

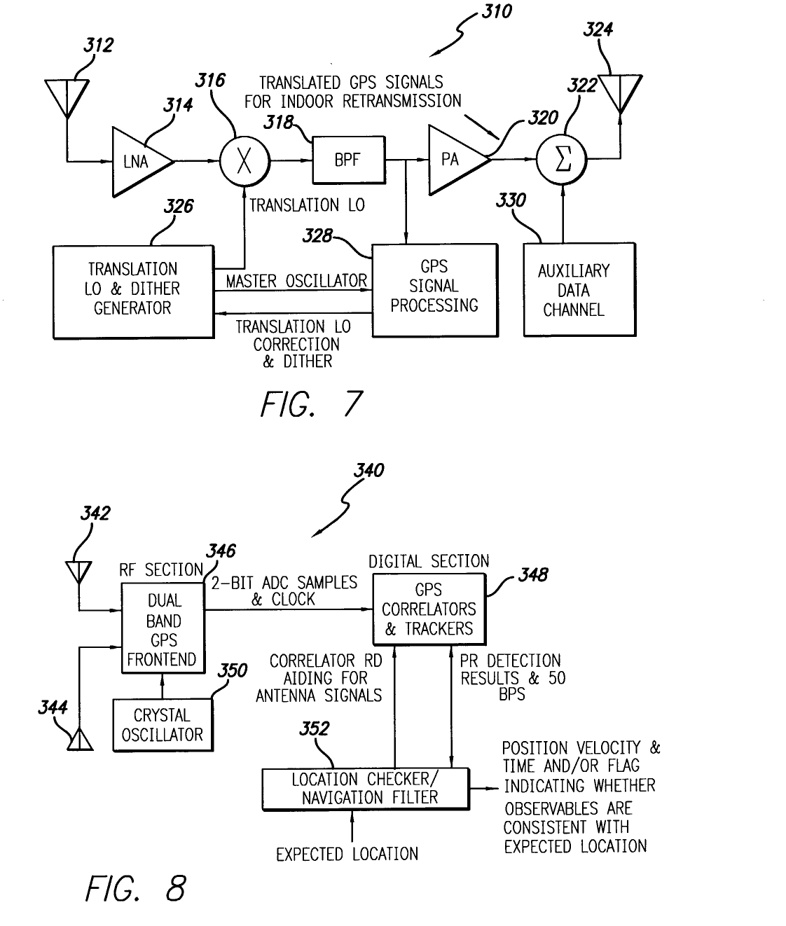

A third embodiment of the invention is illustrated with respect to FIGS. 7-9. The third embodiment is similar to the first embodiment described above, except that translated GPS signals are delivered to the user equipment via RF signals instead of via the cable plant. This embodiment would be advantageous in delivering assisted GPS signals to a large indoor location, such as a mall, arena or convention center. FIG. 7 illustrates a block diagram of a master GPS signal translator 310 to be located so as to have clear sky access. The master GPS signal translator 310 would translate a modestly filtered version of the entire L1 modulated carrier to another frequency.

The master GPS signal translator 310 further comprises an L1 antenna 312, a low noise amplifier (LNA) 314, a translation local oscillator 326, a mixer 316, a bandpass filter 318, a power amplifier 320, and an indoor distribution antenna 324. The L1 antenna 312 positioned with clear sky access receives the L1 modulated carrier and passes that signal through the LNA 314 to the mixer 316. The translation local oscillator 326 produces a precise translation local oscillator (LO) signal that is provided to the mixer 316. The mixer 316 combines the received L1 modulated carrier with the translation LO signal to translate (or downconvert) the received L1 modulated carrier to a lower center frequency. The translated L1 modulated carrier is passed through the bandpass filter 318 to eliminate any extraneous frequency components, and the power amplifier 320 boosts the filtered signal to a broadcast level. The amplified, filtered, and translated L1 modulated carrier is broadcasted by the distribution antenna 324. It is anticipated that the translated L1 modulated carrier be radiated at a frequency different than the GPS standard center frequency. The distribution antenna 324 broadcasts the translated L1 modulated carrier using any conventional RF communication channel.

As in the preceding embodiments, an optional auxiliary data channel 330 can carry ancillary control data. The master GPS signal translator 310 further comprises a summing device 322 that combines the translated L1 modulated carrier with the auxiliary data channel 330 prior to broadcast. The master GPS signal translator 310 may also include a GPS signal-processing device 328 coupled to the signal path to receive the translated and filtered L1 modulated carrier prior to the amplification stage. The GPS signal processing device 328 can recover the highly accurate clock calibration signals from the L1 modulated carrier, and use those signals to measure the accuracy of a master oscillator signal produced by the translation local oscillator 326. Corrections to the master oscillator signal can be conveyed back to the translation local oscillator 326 directly for application by a dither generator, or can be broadcast to the user equipment via the auxiliary data channel 330.

FIG. 8 illustrates a block diagram of an A-GPS end user receiver 340. The end user receiver 340 would be located within the indoor location. The end user receiver 340 may be included as part of the terminal equipment or may comprise a separate, stand-alone device, such as a wireless device including a personal digital assistant (PDA), cellular telephone, laptop computer, and the like. The end user receiver 340 comprises an L1 antenna 342, a translated RF antenna 344, an RF section including a dual band GPS front end 346 and crystal oscillator 350, and a digital section including GPS correlators/trackers 348 and location checker/navigation filter 352. The L1 antenna 342 is positioned indoors without clear sky access and therefore receives only an attenuated L1 modulated carrier. The translated RF antenna 344 is adapted to receive RF signals broadcast by the distribution antenna 324 (see FIG. 7). The dual band GPS front end 346 is connected to both the L1 antenna 342 and the translated RF antenna 344 in order to receive GPS signals from each of these sources.

As described above with respect to the first embodiment, the dual band GPS front end 346 produces digital samples (e.g., two bits per sample) and a clock signal used as the sampling rate. The crystal oscillator 350 provides the dual band GPS front end 346 with a local oscillator signal used to downconvert the GPS signals received from both the L1 antenna 342 and the translated RF antenna 344, and also provides the clock signal for producing the digital samples of the RF signals. Within the digital section, the GPS correlators/trackers 348 receive the digital samples and the clock signal, and attempt to correlate the digital samples to the satellite PN codes. The correlators/trackers 348 recover the 50 bps broadcast data message and determine the pseudorange (PR) using information contained in the broadcast data message. If the GPS signals received from the L1 antenna 342 are too weak to recover the 50 bps broadcast data message, then this message can be recovered from the translated GPS signals received via the translated RF antenna 344. The location checker/navigation filter 352 uses the pseudorange information from the correlators/trackers 348 to estimate Range/Doppler (RD) to assist the correlators/trackers 348 in correlating with the digital samples of GPS signals received from the L1 antenna 342 so that pseudorange information can be determined for these attenuated signals. The location checker/navigation filter 352 ultimately determines the user equipment location information. The location checker/navigation filter 352 may also generate a flag indicating whether the determined location is consistent with an expected location.

In addition to providing the location of the GPS satellites used in the foregoing equations, the 50 bps broadcast data message recovered from the GPS signals received via the translated RF antenna 344 is advantageous in figuring out more accurately the frequency of the translation LO signal used by the master GPS signal translator 310 (see FIG. 7) to translate the GPS signals. Knowledge of the frequency of the translation LO can then be used to discipline the crystal oscillator 350 used to downconvert the GPS signals in the user equipment. The time bias solution provided by the location checker/navigation filter 352 can be used to determine the exact frequency of the crystal oscillator 350, enabling the correlators to hone in quickly on a much narrower range of bins, thereby substantially reducing the number of correlators needed to perform the search. The location checker/navigation filter 352 may also receive an expected location profile to further reduce the number of Range bins to search.

It will be appreciated that there will be an RF delay analogous to the cable plant delay discussed above. In most cases, the RF delay will be short since the range of the RF broadcast is short. But, if a high power RF transmitter is used for longer range broadcasts, the RF delay may be more significant and may have to be measured in order to yield accurate end user position information.

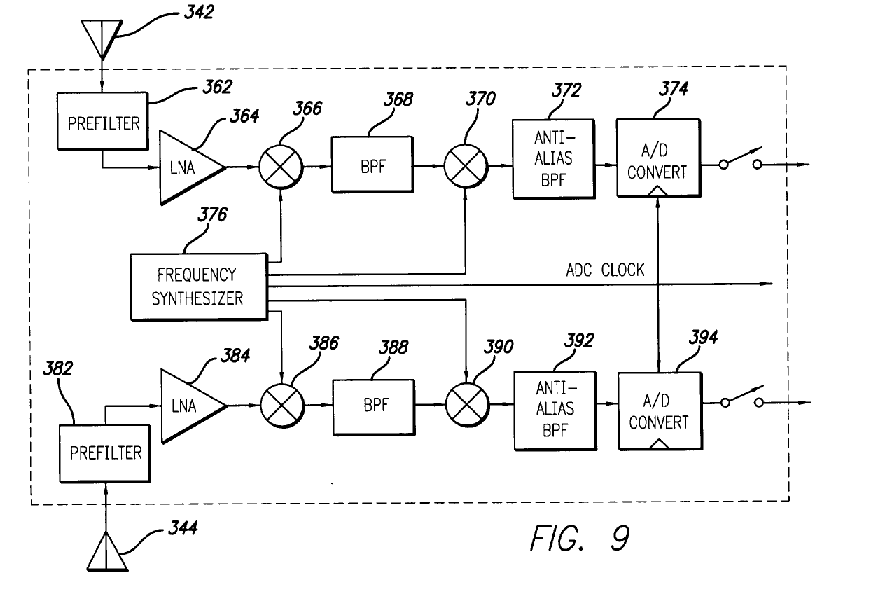

FIG. 9 shows a block diagram of an exemplary dual band GPS front end 346 in greater detail. The dual band GPS front end 346 includes two parallel signal processing streams, including a first stream for processing GPS signals received over the L1 antenna 342 and a second stream for processing GPS signals received over the translated RF antenna 344. The first signal processing stream includes a prefilter 362, low noise amplifier 364, first mixer stage 366, bandpass filter 368, second mixer stage 370, anti-aliasing bandpass filter 372, and A/D converter 374. Likewise, the second signal processing stream includes a prefilter 382, low noise amplifier 384, first mixer stage 386, bandpass filter 388, second mixer stage 390, anti-aliasing bandpass filter 392, and A/D converter 394. The two signal streams have a common frequency synthesizer 376. Other than the RF source for the second signal processing stream, the dual band GPS front end 346 operates substantially the same as the dual band GPS front end 134 described above with respect to FIG. 4.

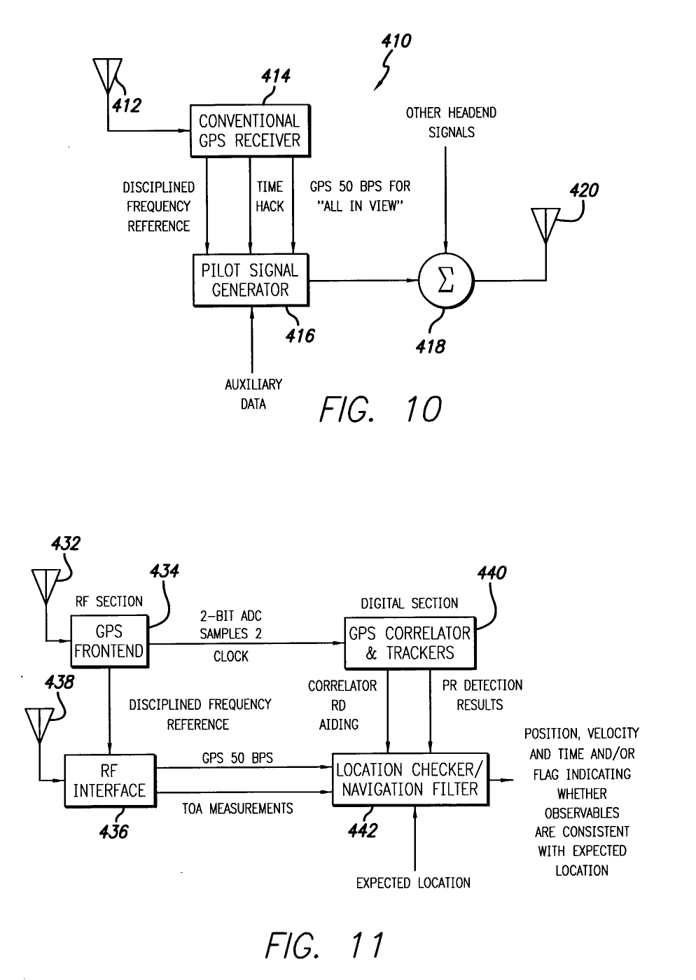

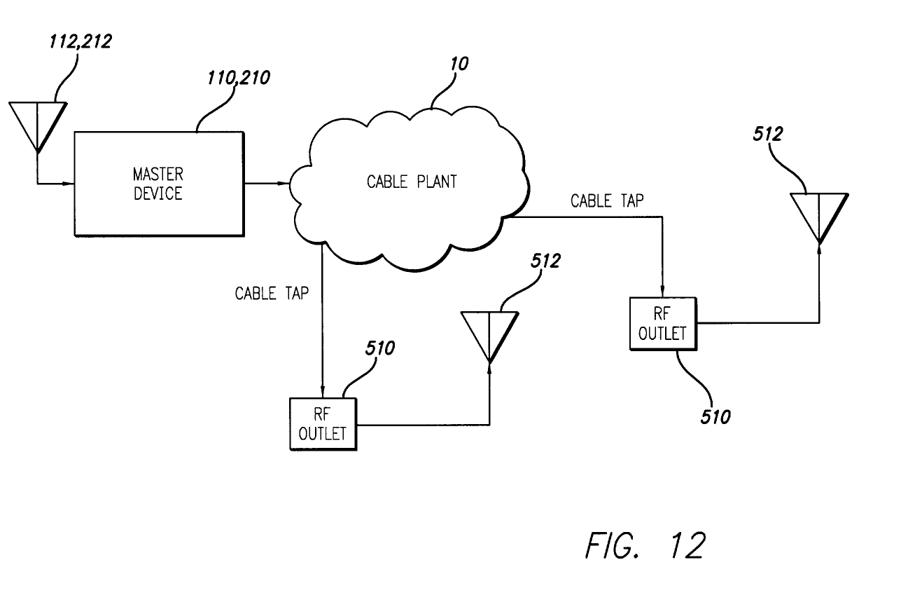

A fourth embodiment of the invention is illustrated with respect to FIGS. 10-11. The fourth embodiment is similar to the second embodiment described above, except that a GPS pilot signal is delivered to the end user via RF signals instead of via the cable plant. As in the immediately preceding embodiment, this embodiment would be advantageous in assisting GPS operation in a large indoor location, such as a mall, arena or convention center. FIG. 10 illustrates a block diagram of a master GPS pilot signal generator 410 having an L1 antenna 412 located so as to have clear sky access. The master GPS pilot signal generator 310 produces a pilot signal that is sent via RF to an A-GPS unit at the user equipment end to assist in downconverting attenuated GPS signals.

The master GPS pilot signal generator 410 further comprises a conventional GPS receiver 414, a pilot signal generator 416, and an indoor distribution antenna 420. The L1 antenna 412 positioned with clear sky access receives the L1 modulated carrier and passes that signal to the GPS receiver 414. The GPS receiver 414 produces a disciplined frequency reference, a time hack, and the 50 bps broadcast data messages fro all satellites in view. The pilot signal generator 416 receives these three signals, and broadcasts via the antenna 420 a frequency disciplined pilot signal containing the 50 bps broadcast data message. The master GPS pilot signal generator 410 may optionally include a summing device 418 that combines the disciplined pilot signal with other signals such as the composite of signals from the headend 12.

It is anticipated that the disciplined pilot signal be radiated at a frequency different than the GPS standard center frequency. As in the preceding embodiments, the pilot signal may also include optional auxiliary control data. The antenna 420 broadcasts the disciplined pilot signal using any conventional RF communication channel. Alternatively, information content placed on the pilot channel might be digitally multiplexed onto other conventional communications links such as a satellite link, paging channel link, an Advanced Television Systems Committee (ATSC) standard signal, a Digital Television (DTV) signal, an FM radio subcarrier, a cellular radio standard signal, and the like. For example, a digital subchannel of these exemplary RF communication channels may carry the pilot signal information content, and furthermore, may use the frequency discipline information to discipline their own transmissions. Alternatively, an A-GPS end user receiver 430 (see below with respect to FIG. 11) located at the master site can measure the actual frequency of transmission of a-conventional communication system and then convey frequency offset information via the pilot digital subchannel.

FIG. 11 illustrates a block diagram of an A-GPS end user receiver 430. The end user receiver 430 would be located within the indoor location. The end user receiver 430 may be included as part of the terminal equipment or may comprise a separate, stand-alone device, such as a wireless device including a personal digital assistant (PDA), cellular telephone, laptop computer, and the like. The end user receiver 430 comprises an L1 antenna 432, a pilot signal RF antenna 438, an RF section including a GPS front end 434 and RF interface 436, and a digital section including GPS correlators/trackers 440 and location checker/navigation filter 442. The L1 antenna 432 is positioned indoors without clear sky access and therefore receives only an attenuated L1 modulated carrier. The GPS front end 434 is connected to the L1 antenna 432 in order to receive GPS signals that may be attenuated as discussed above. The pilot signal RF antenna 438 is adapted to receive the pilot signal broadcast by the distribution antenna 420 (see FIG. 10). The RF interface 436 is connected to the pilot signal RF antenna 438 in order to receive the pilot signal.

The RF interface 436 receives and demodulates the pilot signal to recover the disciplined frequency reference, the time hack, and the information contained within the 50 bps broadcast data message. The RF interface 436 provides the disciplined frequency reference to the GPS front-end 434, which uses that information to discipline the crystal oscillator included therein used to downconvert the GPS signals received from the L1 antenna 432. As described above with respect to the second embodiment, the GPS front end 434 produces digital samples (e.g., two bits per sample) and a clock signal used as the sampling rate.

Within the digital section, the GPS correlators/trackers 440 receive the digital samples and the clock signal, and attempt to correlate the digital samples to the satellite PN codes. The correlators/trackers 440 recover the 50 bps broadcast data message and determine the pseudorange (PR) using information contained in the broadcast data message. If the GPS signals received from the L1 antenna 432 are too weak to recover the 50 bps broadcast data message, then this message can be recovered from the pilot signal received via the RF antenna 438. The location checker/navigation filter 442 uses the pseudorange information from the correlators/trackers 440 to estimate Range/Doppler (RD) to assist the correlators/trackers 440 in correlating with the digital samples of GPS signals received from the L1 antenna 432 so that pseudorange information can be determined for these attenuated signals. The location checker/navigation filter 442 ultimately determines the user equipment location information. The location checker/navigation filter 442 may also generate a flag indicating whether the determined location is consistent with an expected location. As described above, correlator counts can be reduced by providing the location checker/navigation filter 240 with a time hack of sufficient accuracy to permit searching fewer than all PN code phases. In one embodiment, an external fill device may be used to load in time and position.

A fifth embodiment of the invention is illustrated with respect to FIG. 12. The fourth embodiment combines aspects of each of the preceding embodiments described above. Assisted GPS signals, either translated as in the first embodiment or in the form of a pilot signal as in the second embodiment, are delivered via the cable plant to RF outlets that are disposed within an indoor location, such as a mall, arena or convention center. The RF outlets then broadcast the assisted GPS signals via RF to the user equipment. This embodiment would be advantageous in that it would not require physical modification the indoor location, but would merely require access to the cable plant within the indoor location.

In FIG. 12, a master GPS device 110 (see FIG. 2) or 210 (see FIG. 5) is located at the headend 12 and is coupled to L1 antenna 112, 212 having clear sky access. The master GPS device 110 injects an assisted GPS signal into the cable plant 10, where it is accessed by a plurality of RF outlets 510 that may be disposed within an indoor location. The RF outlets 510 reradiate the assisted GPS signal as an RF signal via respective RF antennas 512. User equipment devices as described above either with respect to FIG. 8 or FIG. 11 would then receive the reradiated assisted GPS signals and recover location information substantially as described above. With respect to a translated GPS embodiment, signals from plural RF outlets can be separated even though they use the same frequency band and have overlapping geographic coverage because the GPS signals utilize code division multiple access (CDMA) modulation. Alternatively, the RF outlets 510 may be adapted to each utilize delay and/or frequency offsets to ensure resolvable separations under RF coverage overlap conditions. It may also be desirable to utilize unlicensed frequency bands (e.g., 2400 MHz, 950 MHz, etc.) in order to avoid conflict with other licensed RF systems.

Having thus described preferred embodiments of an assisted GPS signal processing and detection system for indoor location determination, it should be apparent to those skilled in the art that certain advantages of the above-described system have been achieved. It should also be appreciated that various modifications, adaptations, and alternative embodiments thereof may be made within the scope and spirit of the present invention. The invention is further defined by the following claims.

What is claimed is:

1. A system for obtaining position information from satellite navigation signals, comprising:
a master navigation signal receiver having an antenna disposed with clear sky access to a plurality of navigation satellites, said master navigation signal receiver receiving satellite navigation signals from said plurality of navigation satellites, and relaying an assisted satellite navigation signal via a medium, said assisted navigation signal including at least one of satellite location information, clock correction information, and frequency discipline information; and
at least one end user signal receiver having an antenna, said at least one end user signal receiver coupled to said medium to receive said assisted navigation signal from said master navigation signal receiver, said at least one end user signal receiver also receiving said satellite navigation signals directly through said antenna;
wherein, said satellite navigation signals may be at least partially attenuated prior to receipt by said at least one end user signal receiver by passing through physical structures, and in such case, said at least one end user signal receiver recovering end user position information from said at least partially attenuated satellite navigation signals by use of said assisted navigation signal.

2. The system of claim 1, wherein said at least one end user signal receiver comprises at least one correlator adapted to correlate said satellite navigation signals to known pseudorandom codes for said satellites by searching a plurality of Range and Doppler combinations of said pseudorandom codes.

3. The system of claim 2, wherein said assisted navigation signal includes satellite location information permitting said at least one end user receiver to determine pseudorange to said satellites and thereby reduce said plurality of Range and Doppler combinations in a Range dimension.

4. The system of claim 2, wherein said assisted navigation signal includes clock rate correction information permitting said at least one end user receiver to determine a time bias of said satellite navigation signals and thereby reduce said plurality of Range and Doppler combinations in a Doppler dimension.

5. The system of claim 1, wherein the medium further comprises a cable plant coupling said master navigation signal receiver with said at least one end user signal receiver.

6. The system of claim 5, wherein the master navigation signal receiver is disposed at a headend of the cable plant.

7. The system of claim 1, wherein the medium further comprises an RF communication channel between said master navigation signal receiver and said at least one end user signal receiver.

8. The system of claim 7, wherein the RF communication channel further comprises a paging channel link.

9. The system of claim 7, wherein the RF communication channel further comprises an Advanced Television Systems Committee (ATSC) standard signal with said assisted navigation signal carried in a digital subchannel thereof.

10. The system of claim 7, wherein the RF communication channel further comprises a Digital Television (DTV) signal with said assisted navigation signal carried in a digital subchannel thereof.

11. The system of claim 7, wherein the RF communication channel further comprises a cellular radio standard signal with said assisted navigation signal carried in a digital subchannel thereof.

12. The system of claim 1, wherein the medium further comprises a combination of a cable plant and an RF connection between said master navigation signal receiver and said at least one end user signal receiver.

13. The system of claim 1, wherein the assisted navigation signal further comprises said satellite navigation signals from said plurality of navigation satellites translated to a selected frequency.

14. The system of claim 13, wherein said selected frequency coincides with a selected vacant NTSC television channel.

15. The system of claim 1, wherein the assisted navigation signal further comprises auxiliary data.

16. The system of claim 13, wherein the master navigation signal receiver further comprises a translation local oscillator used to translate said satellite navigation signals to the selected frequency.

17. The system of claim 16, wherein the assisted navigation signal further comprises frequency data of the translation local oscillator.

18. The system of claim 17, wherein said at least one end user signal receiver further comprises a crystal oscillator, said frequency data being used by said at least one end user signal receiver to discipline operation of said crystal oscillator.

19. The system of claim 5, wherein said at least one end user signal receiver further comprises means for determining a time delay of said cable plant, said time delay being used to reduce said plurality of Range and Doppler combinations in a Range dimension.

20. The system of claim 1, wherein the assisted navigation signal further comprises a disciplined GPS pilot signal containing a broadcast data message from all satellites in view at the master navigation signal receiver.

21. The system of claim 20, wherein the assisted navigation signal further comprises an accurate time hack.

22. The system of claim 1, further comprising at least one RF outlet coupled to the master navigation signal receiver via a cable plant, said at least one RF outlet broadcasting said assisted navigation signal to said at least one end user signal receiver via an RF connection.

23. A system for obtaining position information from satellite navigation signals, comprising:
a master navigation signal receiver having an antenna disposed with clear sky access to a plurality of navigation satellites, said master navigation signal receiver receiving satellite navigation signals from said plurality of navigation satellites, and relaying an assisted satellite navigation signal via a medium comprising a cable plant, said assisted navigation signal comprising said satellite navigation signals from said plurality of navigation satellites translated to a selected frequency; and
at least one end user signal receiver having an antenna, said at least one end user signal receiver coupled to said medium to receive said assisted navigation signal from said master navigation signal receiver, said at least one end user signal receiver also receiving said satellite navigation signals directly through said antenna;
wherein, said satellite navigation signals may be at least partially attenuated prior to receipt by said at least one end user signal receiver by passing through physical structures, and in such case, said at least one end user signal receiver recovering end user position information from said at least partially attenuated satellite navigation signals by use of said assisted navigation signal.

24. The system of claim 23, wherein said at least one end user signal receiver comprises at least one correlator adapted to correlate the satellite navigation signals to known pseudorandom codes for said satellites by searching a plurality of Range and Doppler combinations of said pseudorandom codes.

25. The system of claim 24, wherein said at least one end user signal receiver recovering satellite location information from said assisted navigation signal to permit a determination of pseudorange to said satellites and thereby reduce said plurality of Range and Doppler combinations in a Range dimension.

26. The system of claim 24, wherein said at least one end user signal receiver recovering clock correction information from said assisted navigation signal to permit a determination of time bias of said satellite navigation signals and thereby reduce said plurality of Range and Doppler combinations in a Doppler dimension.

27. The system of claim 23, wherein said selected frequency coincides with a selected vacant NTSC television channel.

28. The system of claim 23, wherein the assisted navigation signal further comprises auxiliary data.

29. The system of claim 23, wherein the master navigation signal receiver further comprises a translation local oscillator used to translate said satellite navigation signals to the selected frequency.

30. The system of claim 29, wherein the assisted navigation signal further comprises frequency data of the translation local oscillator.

31. The system of claim 30, wherein said at least one end user signal receiver further comprises a crystal oscillator, said frequency data being used by said at least one end user signal receiver to discipline operation of said crystal oscillator.

32. The system of claim 24, wherein said at least one end user signal receiver further comprises means for determining a time delay of said cable plant, said time delay being used to reduce said plurality of Range and Doppler combinations in a Range dimension.

33. The system of claim 23, further comprising at least one RF outlet coupled to the master navigation signal receiver via a cable plant, said at least one RF outlet broadcasting said assisted navigation signal to said at least one end user signal receiver via an RF connection.

34. The system of claim 23, wherein the master navigation signal receiver is disposed at a headend of the cable plant.

35. A system for obtaining position information from satellite navigation signals, comprising:
a master navigation signal receiver having an antenna disposed with clear sky access to a plurality of navigation satellites, said master navigation signal receiver receiving satellite navigation signals from said plurality of navigation satellites, and relaying an assisted satellite navigation signal via a medium comprising a cable plant, said assisted navigation signal comprising a disciplined GPS pilot signal containing a broadcast data message from all satellites in view at the master navigation signal receiver; and
at least one end user signal receiver having an antenna, said at least one end user signal receiver coupled to said medium to receive said assisted navigation signal from said master navigation signal receiver, said at least one end user signal receiver also receiving said satellite navigation signals directly through said antenna;
wherein, said satellite navigation signals may be at least partially attenuated prior to receipt by said at least one end user signal receiver by passing through physical structures, and in such case, said at least one end user signal receiver recovering end user position information from said at least partially attenuated satellite navigation signals by use of said assisted navigation signal.

36. The system of claim 35, wherein said at least one end user signal receiver comprises at least one correlator adapted to correlate the satellite navigation signals to known pseudorandom codes for said satellites by searching a plurality of Range and Doppler combinations of said pseudorandom codes.

37. The system of claim 36, wherein said assisted navigation signal includes satellite location information permitting said at least one end user receiver to determine pseudorange to said satellites and thereby reduce said plurality of Range and Doppler combinations in a Range dimension.

38. The system of claim 36, wherein said assisted navigation signal includes clock correction information permitting said at least one end user receiver to determine a time bias of said satellite navigation signals and thereby reduce said plurality of Range and Doppler combinations in a Doppler dimension.

39. The system of claim 35, wherein the assisted navigation signal further comprises auxiliary data.

40. The system of claim 36, wherein said at least one end user signal receiver further comprises means for determining a time delay of said cable plant, said time delay being used to reduce said plurality of Range and Doppler combinations in a Range dimension.

41. The system of claim 35, wherein the assisted navigation signal further comprises an accurate time hack.

42. The system of claim 35, further comprising at least one RF outlet coupled to the master navigation signal receiver via a cable plant, said at least one RF outlet broadcasting said assisted navigation signal to said at least one end user signal receiver via an RF connection.

43. The system of claim 35, wherein the master navigation signal receiver is disposed at a headend of the cable plant.
